(19) United States
(12) Patent Application Publication
(10) Pub. No.: US 2006/0212438 A1
(43) Pub. Date: Sep. 21, 2006

(54) SQL injection protection by variable normalization

(76) Inventor: Ming Sum Sam Ng, Hong Kong (HK)

Correspondence Address: COOPER & DUNHAM, LLP, 1185 AVENUE OF THE AMERICAS, NEW YORK, NY, 10036, US

(21) Appl. No.: 11/081,298

(22) Filed: Mar. 16, 2005

(51) Int. Cl. G06F 17/30

(52) U.S. Cl. 707/4

(57) ABSTRACT

The invention provides a method for determining allowability of a structured query language (SQL) statement, the method comprising the steps of normalizing the SQL statement, and comparing the normalized SQL statement with a predetermined set of allowable statements.

### FIELD OF THE INVENTION

The present invention is directed to security protection for computer systems. In particular, the present invention relates to Structured Query Language (SQL) injection protection of computer systems or applications by variable normalization that is compatible with a wide array of computer systems, easy to use, flexible, and that operates at a client side to reduce susceptibility to server failure.

### BACKGROUND OF THE INVENTION

SQL is an American National Standards Institute (ANSI) standard computer language for accessing and manipulating relational database systems. Examples of common database systems which may be accessed using SQL include Microsoft Access, Microsoft SQL Server, IBM DB2, Informix, Oracle, and Sybase.

A relational database system contains one or more objects called tables which are identified by names and made up of columns and rows. The data or information for the database are stored in the tables. Table columns contain the column name, data type, and any other attributes for a column. Table rows contain records or data corresponding to the columns.

SQL statements include keywords and may be used to query, retrieve, delete, insert, and update data in the database. Although there are several different versions of the SQL language, the ANSI SQL standard requires a compliant version of SQL to support certain major keywords in a similar manner. Examples of such major keywords include SELECT, UPDATE, DELETE, INSERT, and WHERE.

SQL provides many features for manipulation of data contained in the database, such as the commands included in SQL Data Definition Language (DDL) and SQL Data Manipulation Language (DML). DDL permits database tables to be created or deleted, and may be used to define indexes, specify links between tables, and impose constraints between database tables. Some important DDL statements include CREATE TABLE, ALTER TABLE, and DROP TABLE, for creating, modifying, and deleting tables, respectively. Additionally, DDL includes the statements CREATE INDEX, for creating an index or search key; and DROP INDEX, for deleting an index.

DML includes syntax to update, insert, and delete records. Examples of query and update commands include SELECT, for extracting data from a database table; UPDATE, for updating data in a database table; DELETE, for deleting data from a database table; and INSERT INTO, for inserting new data into a database table.

An increasingly common problem related to computer systems is that of security attacks performed in an attempt to infiltrate the system. Attacks may be carried out to access, modify, or destroy data stored on the computer system, and may be launched locally or from a remote location via a communication network such as the Internet.

SQL injection is a common application-layer attack whereby a malicious user attempts to inject or insert SQL code created to manipulate a relational database. SQL injection may be executed over a standard Internet connection via a web page, and may be performed through use of an Internet application utilizing ASP, JSP, PHP, CGI, etc., rather than on the web server or services running in the operating system.

In an SQL injection attack, the malicious code may be injected via standard applications through websites that include web pages allowing submission of data by a user, for example, user login pages, search pages, feedback submission pages, and the like. The data are then used to make an SQL query to a connected database. Another SQL injection technique may include use of hypertext markup language (HTML) pages which utilize a POST command to send parameters to another ASP page.

In a common example of a user login webpage, a user may be validated by provision of a HTML form through which the user can enter alphanumeric strings representing a username and a password. The username and password are then used to build a SQL query to the database to check if the entered username and password exist.

An SQL injection attack on such a system involves inputting specially-crafted parameters into the website entry fields, such as username and/or password fields, that may change the resulting created SQL query and thus perform some action on the connected database. The special parameters may be constructed such that they change the SQL statement structure and allow the malicious user to execute arbitrary SQL commands remotely.

For example, a website login page may request a user to enter a username and password. The user may enter, for example, a string such as “john” to represent a username, and a string such as “mysecret” to represent a password. When the username and password strings are submitted via the webpage, the web application may insert the submitted values into an SQL statement and construct an SQL command in the following format:
SELECT*FROM user_table
   WHERE user_id=‘john’ and password=‘mysecret’

As can be seen above, the strings “john” and “mysecret” have been included in the constructed SQL command. The SQL command set forth above may then be issued to the database to authenticate the user. If the strings entered are valid, the query will enter a non-empty result set, authorizing the web application login.

In carrying out an SQL injection attack, however, a malicious party may enter a username string and characters in place of a valid password string such as:
or 1=1--

Upon construction of an SQL command using these submitted entries in the same manner as that set forth above, the web application produces a SQL command such as:
SELECT*FROM user_table
   WHERE user_d=‘john’ and password=‘′ or 1=1--‘.

When submitted to the database, the value “or 1=1” in the malicious SQL command causes the query to return all records in the user_table of the database. The value “--” comments out the last “′” appended by the system, causing the query to return a non-empty result set without errors.

Existing measures to counter SQL injection attacks include use of source code scanning, web application gateways, and network intrusion detection systems (IDS). Such measures, however, are difficult to implement, degrade overall performance, allow for false positives, require changing of source code, and may constitute a single point of failure.

Additionally, verifying all SQL statements before sending the statements to the database may be used to thwart the above-described attack. However, since the SQL statements are dynamically created by the web application, each SQL statement may be unique, making it difficult to pre-define allowable SQL statements.

There remains a need for protection against SQL injection attacks that is compatible with a wide variety of computer systems, that is easy to use, that works on a client side, that is flexible, and that has minimal impact on the overall system.

### SUMMARY OF THE INVENTION

The present invention provides a novel method for determining allowability of a SQL statement, including normalizing the SQL statement and comparing the normalized SQL statement with a predetermined set of allowable statements.

The normalizing may include converting each single-quoted string within the SQL statement to a single character, converting all numbers within the SQL statement to a single numerical digit, storing the converted SQL statement, storing a position-of each variable of the converted SQL statement, storing a type of each variable of the converted SQL statement, and storing a value of each variable of the converted SQL statement.

The predetermined set of allowable statements may include a set of normalized SQL statements along with corresponding variable positions, variable types, and variable requirements. The set of allowable statements may be supplied manually or automatically, and the variable requirements may include variable length, allowed characters, regular expression patterns, minimum values, and maximum values.

The automatically-supplied set of allowable statements may include stored normalized SQL statements and the variable positions and variable types corresponding to the stored normalized SQL statements. The variable requirement may be set to an expected value equal to an original value.

When a normalized SQL statement to be stored in the automatically-supplied set of allowable statements already exists, the normalized SQL statement to be stored and the existing normalized SQL statement may be merged. When they are merged, the normalized SQL statement to be stored and the existing normalized SQL statement are merged by checking each variable requirement stored in the allowable list. The requirements are retained when the checking determines that they are the same, and the variable is set to no requirements when the requirements are not the same.

The comparing may include searching for the SQL statement in the set of allowable statements. When the allowable list contains the SQL statement, verification of each variable value in the SQL statement may be determined by checking it against the variable requirements located in the set of allowable statements. The SQL statement may be allowed when each variable value in the SQL statement is verified.

### BRIEF DESCRIPTION OF THE DRAWINGS

FIG. 1 is a diagram illustrating a conventional computer system.

FIG. 2 is a diagram illustrating an embodiment of the invention.

FIG. 3 is a flowchart illustrating a verification method according to an embodiment of the invention.

FIGS. 4A-4B are diagrams illustrating variable normalization of SQL statements according to an embodiment of the invention.

FIG. 5 is a diagram illustrating a system including three rules defined in an allowable list according to an embodiment of the invention.

FIGS. 6A-6C are diagrams illustrating variable requirement analysis according to an embodiment of the invention.

FIG. 7 is a diagram illustrating an example of verification of an SQL statement according to an embodiment of the invention.

### DETAILED DESCRIPTION OF THE PREFERRED EMBODIMENTS

Reference will now be made in detail to a preferred embodiment of the invention, examples of which are also provided in the following description. Exemplary embodiments of the invention are described in detail, although it will be apparent to those skilled in the relevant art that some features that are not particularly important to an understanding of the invention may not be shown for the sake of clarity.

Furthermore, it should be understood that the invention is not limited to the precise embodiments described below and that various changes and modifications thereof may be effected by one skilled in the art without departing from the spirit or scope of the invention. For example, elements and/or features of different illustrative embodiments may be combined with each other and/or substituted for each other within the scope of this disclosure and appended claims.

In addition, improvements and modifications which may become apparent to persons of ordinary skill in the art after reading this disclosure, the drawings, and the appended claims are deemed within the spirit and scope of the present invention.

The present invention is directed to a novel method for protecting a computer system from SQL injection attacks.

FIG. 1 is a diagram illustrating a conventional computer system including a database application 12, a connectivity driver 14, and a database server 16. In the conventional system, local function calls may be made from the application 12 to the connectivity driver 14, and local function calls or remote network calls may be made from the connectivity driver 14 to the database server 16.

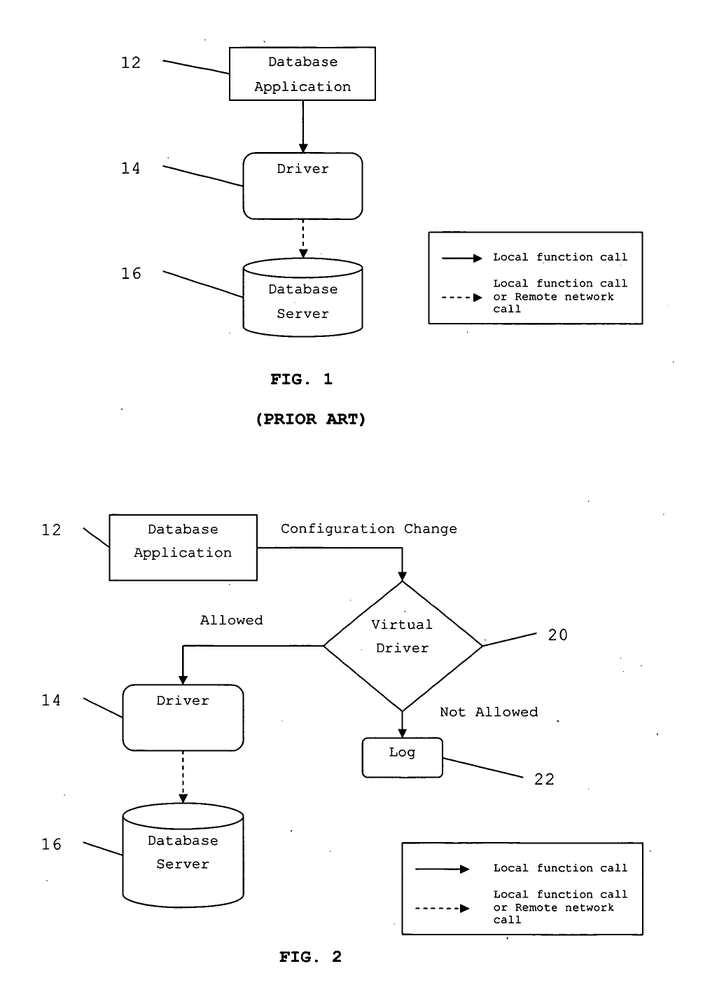

FIG. 2 illustrates a computer system according to an embodiment of the invention. The computer system of the embodiment includes a virtual database connectivity driver 20. Local function calls may be made from the application 12 to the virtual connectivity driver 20, and from the virtual connectivity driver to the original connectivity driver 14. Local function calls or remote network calls may be made from the original connectivity driver 14 to the database server 16. Additionally, log device 22 is included, whereby local function calls may be made from the virtual connectivity driver 20 to the log device.

The structure of a preferred embodiment of the invention will be described below with reference to FIG. 2.

A preferred embodiment of the method of the present invention includes real-time, call-level (API-level) monitoring of SQL commands sent from the application 12 to the database server 16 in real time, and monitoring response data sent from the database server 16 to the application 12. An auto-learning algorithm may be used to define an allowable set of SQL commands.

The monitoring of SQL commands and responses may be performed by implementation of a virtual database connectivity driver 20. Upon implementation, the application 12 may communicate with the database server 16 via direct connection to the virtual database connectivity driver 20 instead of by direct connection with the original database connectivity driver 14.

The virtual database connectivity driver 20 may therefore operate as a proxy, receiving requests from the application 12, validating the requests, and calling the original database connectivity driver 14 on behalf of the application when the request is successfully validated and therefore allowed.

When the request is not allowed, information may be sent to a log 22 device. The log 22 device may include a storage device to store the status of the disallowed request, and additionally may produce an alert to notify of disallowance of the request.

Upon sending of response data, the virtual database connectivity driver 20 may receive the response data from the original database connectivity driver 14, validate the response data, and forward the response data to the application 12 when the response is successfully validated.

An allowable set of SQL commands may be specified by an auto-learning procedure performed by the virtual database connectivity driver 20.

Installation of the Virtual Database Connectivity Driver

The virtual database connectivity driver 20 may be installed on a computer system upon which the application 12 is running or on a computer system connected via a communication network to the computer system upon which the application is running. Installation may be performed locally from recording media, remotely via a communication network, or by any other suitable installation procedure.

After installation of the virtual database connectivity driver 20, the application 12 may be configured to allow it to connect to the virtual database connectivity driver instead of the original database connectivity driver 14. Application configuration may be performed by modifying a connection string corresponding to the application 12 that identifies one or more drivers to be loaded at runtime. Modification of the connection string may include modification of one or more configuration parameters. Parameters and other information corresponding to the application 12 may be stored within a file read by the application, and may include text, numerical, or other suitable data.

Additionally, the virtual database connectivity driver 20 may be configured to identify the original connectivity driver 14 to which it may connect. Configuration of the virtual database connectivity driver 20 to identify the original connectivity driver 14 may include embedding identification information in the connection string, embedding identification information in a file associated with the virtual database connectivity driver 20, or any other suitable configuration mechanism.

Operation of the Virtual Database Connectivity Driver and Variable Normalization

One or more SQL statements may be sent from the application 12 to the virtual database connectivity driver 20. Upon receipt of each SQL statement, the virtual database connectivity driver 20 may determine whether the received SQL statement is allowable through use of a verification procedure.

The composition of each SQL statement received may vary depending on the operation and purpose of the application 12, and upon the type of information entered. For example, username and/or password information may be submitted by users via the application 12 as described above, and the submitted information may change depending upon the identity of each user. Therefore, a variable normalization procedure may be performed on each SQL statement sent from the application 12.

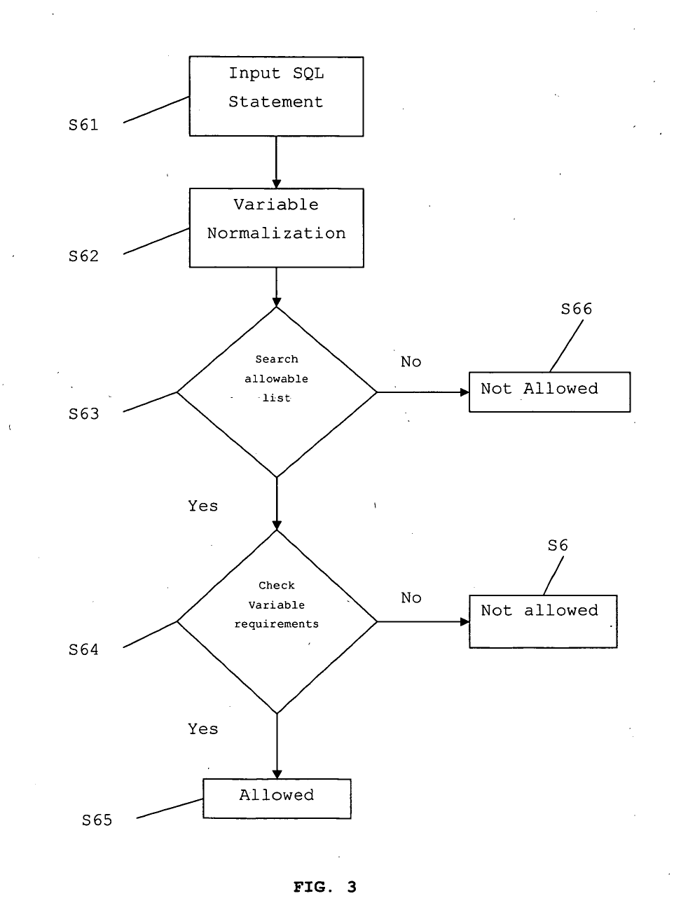

A method for verifying an SQL statement according to an embodiment of the present invention is shown in FIG. 3.

Referring to FIG. 3, after the SQL statement is input at step S61, a variable normalization process is performed on the input SQL statement at step S62. An allowable list is searched to determine if the normalized SQL statement exists in the allowable list at step S63. When the normalized SQL statement does not exist in the allowed list, the statement is blocked at step S66.

When the normalized SQL statement exists in the allowed list, the variables of the statement are checked to determine whether they are within a range of expected values at step S64. When the variables are not within the range of expected values, the statement is blocked at step S67. When the variables are within the range of expected values, the statement is allowed at step S65. The steps of the method described above are described below.

In an embodiment of the invention, the variable normalization procedure may be performed by the virtual database connectivity driver 20. Additionally, the variable normalization procedure may be performed by an application external to the virtual database connectivity driver using the received SQL command as an input.

In performing variable normalization, the received SQL statement is parsed, variable fields contained in the received SQL statement are stripped away, and analysis is performed upon the normalized SQL statement.

Upon stripping away of the variable fields of the received SQL statement, a basic structure of the SQL statement remains. Although as stated above the variable fields may differ between each received SQL statement, the basic structure of each SQL statement sent from the application may generally be similar.

The above-described characteristic of similarity of the basic structure of each received SQL statement may be used to create a pre-defined set of allowable basic structures.

Analysis performed upon the normalized SQL statement may include exact string matching of the normalized SQL statement against an allowable set. Additionally, the analysis may include checking the normalized SQL statement to determine whether it contains any explicitly disallowed values.

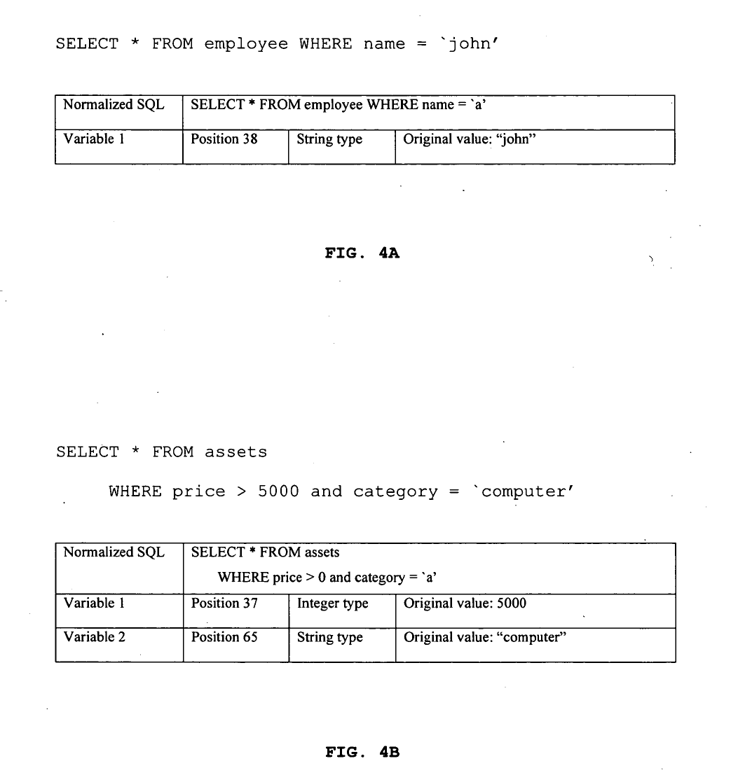

In performing the normalization procedure, as illustrated in FIGS. 4A-4B, variables of the received SQL statement may be modified. For example, as illustrated in FIG. 4A, in an embodiment all single-quoted strings in the received SQL statement may be converted to a single character, such as the letter “a”. Similarly, all positive and negative integers or floating point numbers contained in the received SQL statement may be converted to a single numerical digit, such as “0,” as illustrated in FIG. 4B.

Upon conversion of the variables as described above, the normalized SQL statement may be stored in a data structure called a rule. The normalized SQL statement may be stored in the rule along with corresponding variable information, including variable type and variable position after normalization as shown in FIGS. 4A-4B. The non-variable elements of the received SQL statement, including SQL comments, carriage returns, white spaces, and character cases, are not modified.

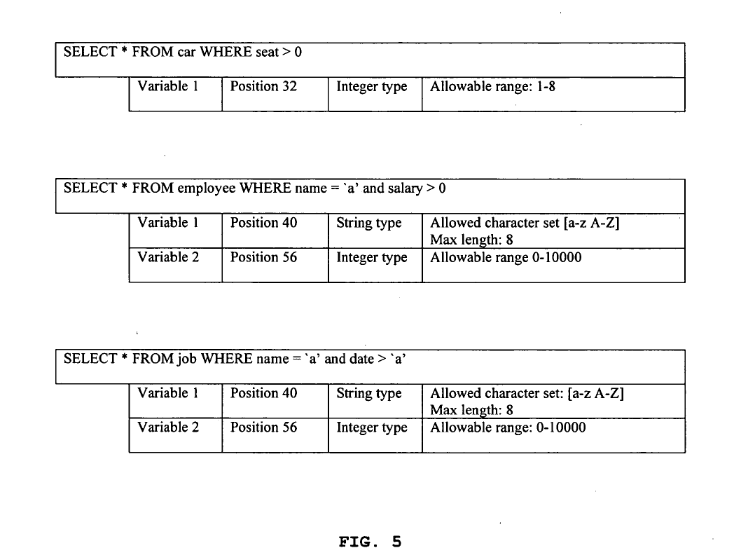

Verification of the normalized SQL statement is performed through comparison of the normalized SQL statement with a pre-defined allowable list. The allowable list may include a set of rules and may store variable requirements, as shown in FIG. 5.

The allowable list may be defined manually by defining each normalized SQL statement along with the requirements of the variables of the normalized SQL statement.

The allowable list may additionally be defined by use of an auto-learning procedure invoked through an auto-learning mode. The auto-learning procedure may allow for the automatic creation of the allowable list by recording all SQL statements.

When the auto-learning mode is used, the variable value of each SQL statement may be stored as an expected value. Initial occurrences of variables may be assumed to have a fixed value. This assumption may be maintained until another SQL statement with the same normalized structure and a different variable value is encountered.

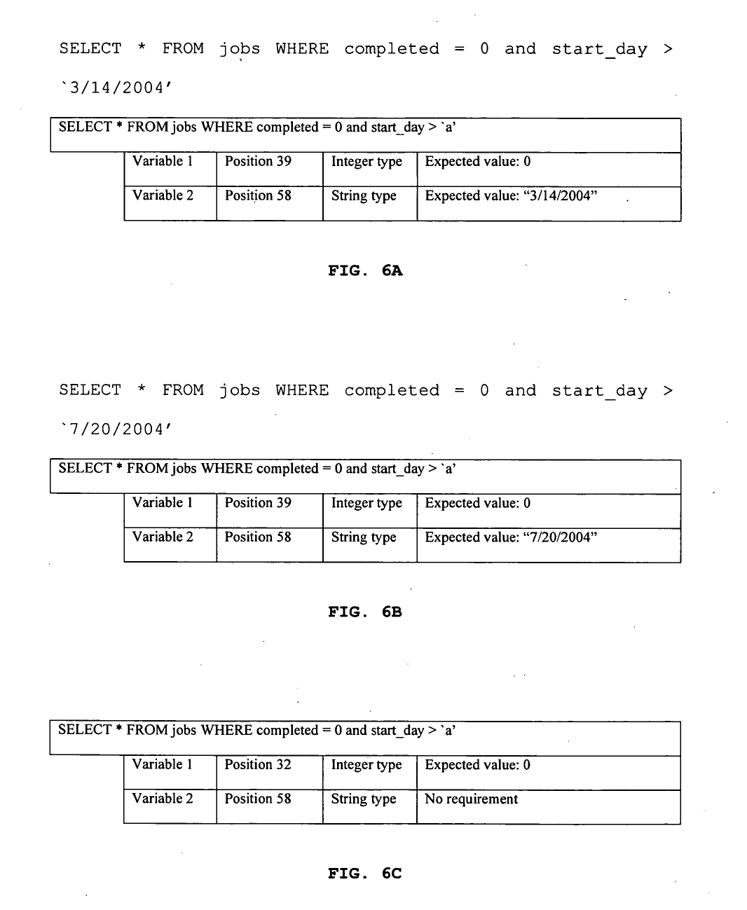

For example, FIGS. 6A-6B each illustrate an SQL statement and corresponding rule. The normalized form of each SQL st atement include “Variable 1” and “Variable 2”. The expected value of “Variable 1” for each normalized SQL statement is “0”. Therefore, the expectation of “0” for “Variable 1” is retained.

The values for “Variable 2”, however, are not the same for both normalized SQL statements. For the SQL statement of FIG. 6A, the value of “Variable 2” is “3/14/2004”, while the value of “Variable 2” in the SQL statement of FIG. 6B is “7/20/2004”.

Therefore, as illustrated in FIG. 6C, further analysis may be performed to group the different values for “Variable 2” to form an additional requirement. The additional requirement may include a character set constraint. Alternatively, a requirement for “Variable 2” may also be removed entirely.

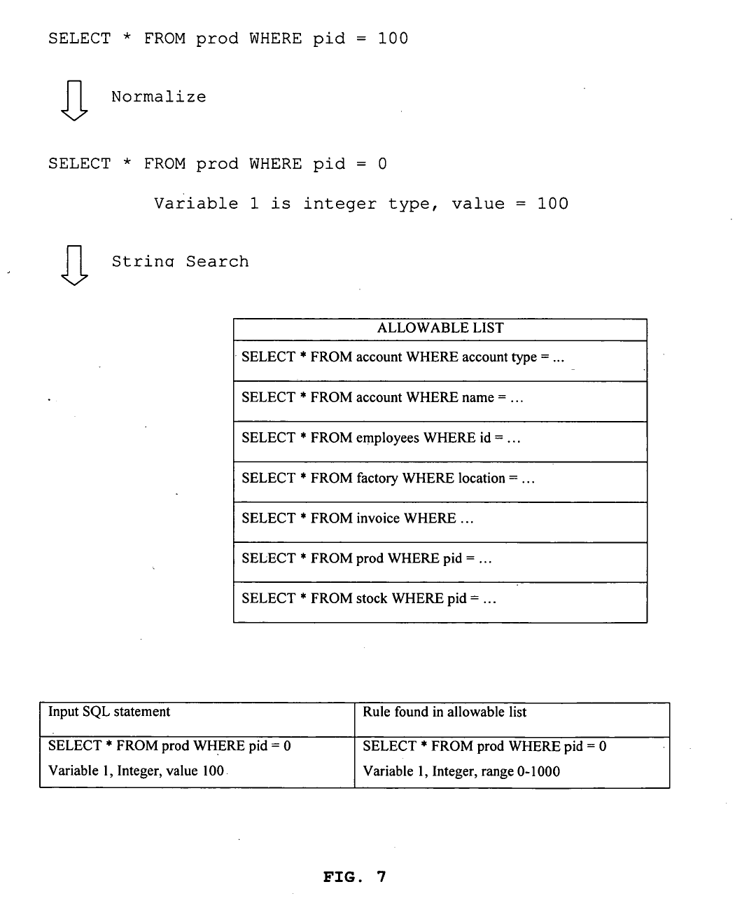

The normalized SQL statement may be verified by searching the allowable list to determine if the normalized SQL statement exists in the allowable list, as shown for example in FIG. 7. When the normalized SQL statement is found to exist in the allowable list, it may allowed when the variables of the normalized SQL statement are within the expected values. When the variables of the normalized SQL statement are not within the expected values the SQL statement may be blocked.

Additionally, the virtual database connectivity driver 20 may verify the variables included in the received SQL statement by feature testing. The feature testing may include testing a length of a string, testing whether the data include a valid date field, testing whether the data include a valid integer, or any other suitable variable verification test.

When verification has been completed by the virtual database connectivity driver 20, the virtual database connectivity driver may then call the original database connectivity driver 14 on behalf of the application 12. After calling the original database connectivity driver 14, the virtual database connectivity driver 20 may wait for a response.

The virtual database connectivity driver 20 may be configured to perform additional analysis of the features of the result set when the original database connectivity driver 14 returns a successful response. The additional analysis of the features of the result set may include, for example, testing a number of expected rows and/or columns, or other suitable tests.

The virtual database connectivity driver 20 may be configured to send information to the log device 22 when the original database connectivity driver 14 returns an error as a response. The log device 22 may produce an alert, and the alert may be sent to the application 12 to inform a user of the application regarding a status of the response.

Additionally, the virtual database connectivity driver 20 may be configured to return a stripped and/or customized error message to the application 12 when the original database connectivity driver 14 returns an error as a response.

Auto-Learning Mode

When the virtual database connectivity driver 20 is configured to perform in an auto-learning mode, after the SQL statement has been received and normalized by the virtual database connectivity driver, the normalized SQL statement and the variable features may be saved, for example to a virtual database connectivity driver configuration file.

When the normalized SQL statement already exists in the virtual database connectivity driver configuration file, the variable features for each field may be grouped together to form a less restrictive feature.

While the invention has been illustrated and described herein with reference to certain preferred embodiments, the present invention is not limited thereto. In particular, the foregoing specification and embodiments are intended to be illustrative and are not to be taken as limiting. Thus, alternatives, such as structural equivalents and modifications will become apparent to those skilled in the art upon reading the foregoing description. Accordingly, such alternatives, changes, and modifications are to be considered as forming a part of the present invention insofar as they fall within the spirit and scope of the appended claims.

What is claimed is:

1. A method for determining allowability of a structured query language (SQL) statement, the method comprising the steps of:
normalizing the SQL statement; and
comparing the normalized SQL statement with a predetermined set of allowable statements.

2. The method of claim 1, wherein the normalizing step includes the steps of:
converting each single-quoted string within the SQL statement to a single character;
converting all numbers within the SQL statement to a single numerical digit;
storing the converted SQL statement;
storing a position of each variable of the converted SQL statement;
storing a type of each variable of the converted SQL statement; and
storing a value of each variable of the converted SQL statement.

3. The method of claim 1, whereby the predetermined set of allowable statements includes a set of normalized SQL statements along with corresponding variable positions, variable types, and variable requirements, wherein
the set of allowable statements may be supplied manually or automatically; and
the variable requirements include variable length, allowed characters, regular expression patterns, minimum values, and maximum values.

4. The method of claim 3, wherein
the automatically-supplied set of allowable statements includes stored normalized SQL statements and the variable positions and variable types corresponding to the stored normalized SQL statements; and
the variable requirement is set to an expected value equal to an original value.

5. The method of claim 4, wherein
when a normalized SQL statement to be stored in the automatically-supplied set of allowable statements already exists, the normalized SQL statement to be stored and the existing normalized SQL statement are merged;
the normalized SQL statement to be stored and the existing normalized SQL statement are merged by checking each variable requirement stored in the allowable list;
the requirements are retained when the checking determines that they are the same; and
the variable is set to no requirements when the requirements are not the same.

6. The method of claim 3, whereby the comparing step comprises the step of searching for the SQL statement in the set of allowable statements, wherein
when the allowable list contains the SQL statement, verification of each variable value in the SQL statement is determined by checking it against the variable requirements located in the set of allowable statements; and
the SQL statement is allowed when each variable value in the SQL statement is verified.
